(19) United States
(12) Patent Application Publication
(10) Pub. No.: US 2006/0199566 A1
(43) Pub. Date: Sep. 7, 2006

(54) Method and apparatus for requesting and providing stored data

(75) Inventors: Byung-Wook Jang, Suwon-si (KR); Ji-Ho Park, Seoul (KR); Dae-Kyu Shin, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/366,670

(22) Filed: Mar. 2, 2006

(30) Foreign Application Priority Data
Mar. 2, 2005 (KR) 2005-17447

(51) Int. Cl. H04M 1/66

(52) U.S. Cl. 455/411

(57) ABSTRACT

A method and apparatus for requesting and providing stored data is provided. The method includes determining whether a data request message is received, searching in stored data for user desired information according to a search condition included in the data request message upon receipt of the data request message, and transmitting the user desired information satisfying the search condition according to a destination included in the data request message.

### PRIORITY

This application claims priority under 35 U.S.C. § 119 to an application entitled “Method and Apparatus for Requesting and Providing Stored Data” filed in the Korean Intellectual Property Office on Mar. 2, 2005 and assigned Serial No. 2005-17447, the contents of which are incorporated herein by reference.

### BACKGROUND OF THE INVENTION

1. Field of the Invention

The present invention generally relates to a method and apparatus for requesting and providing data stored in a terminal in a communication system.

2. Description of the Related Art

Mobile communication terminals that users can carry with them, such as cellular phones and Personal Digital Assistants (PDA), are commonly used. With the development of communication technology, mobile communication terminals provide not only communication functions but also Short Message Service (SMS) functions. Mobile communication terminals also offer additional functions such as phone book functions, scheduling functions, game functions using images and sounds, alarm functions, and MP3 player functions, as well as communication functions.

The SMS functions allow mobile communication terminals to exchange short messages. A service for providing information required for day-to-day activities using the SMS functions has been implemented. For example, mobile communication service operators provide news information, event information, weather information, sports information, stock information, exchange rate information, and traffic information to mobile communication service subscribers using an SMS capable of transmitting simple messages.

A mobile communication terminal receiving a short message from another mobile communication terminal notifies a user of its receipt using a bell sound or vibration. The user checks the received short message and stores or erases the received short message. To send a short message, a user inputs the short message, selects “send”, and then the mobile communication terminal sends the user input short message to a partner as an SMS message.

However, when users do not carry a mobile communication terminal with them, they cannot use a phone book stored in the mobile communication terminal or check an SMS message or a voice message received in the mobile communication terminal. As a result, although users desire to acquire data stored in a remote mobile communication terminal, there exists no technique for supporting the acquisition.

### SUMMARY OF THE INVENTION

It is, therefore, an object of the present invention to provide a method and apparatus for acquiring data stored in a user's terminal through a user desired medium.

To achieve the above and other objects, there is provided an apparatus for providing stored data. The apparatus includes a receiver and a controller. The receiver receives a message. The controller searches in its stored data for user desired information according to a search condition included in a data request message upon receipt of the data request message, and transmits the user desired information satisfying the search condition to a destination included in the data request message.

To achieve the above and other objects, there is also provided a method for requesting stored data in a communication system, in which a first communication device requests data stored in a second communication device. The method includes receiving, as an input from a user, a search condition for searching in the stored data of the second communication device for user desired information if the user selects a data request function, receiving, as an input from the user, a destination to which the user desired information is to be transmitted, and generating a data request message using the input search condition and destination.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a communication system according to an embodiment of the present invention;

FIG. 2 illustrates a message flow diagram for providing data according to an embodiment of the present invention;

FIG. 3 is a block diagram of a mobile communication terminal according to an embodiment of the present invention;

FIG. 4 illustrates search conditions input according to data types;

FIG. 5 illustrates the structure of a data request message according to an embodiment of the present invention;

FIG. 6 illustrates the structure of a data request message according to another embodiment of the present invention;

FIG. 7 is a control flowchart when a terminal transmits a data request message according to an embodiment of the present invention; and

FIG. 8 is a control flowchart when a terminal receives a data request message according to an embodiment of the present invention.

### DETAILED DESCRIPTION OF THE PREFERRED EMBODIMENT

Preferred embodiments of the present invention will now be described in detail with reference to the accompanying drawings.

In the present invention, when a communication terminal receives a data request message in a conventional message form, user desired information satisfying a data search condition included in the received data request message is searched for and the searched data is sent to a destination included in the received data request message.

At this time, the communication terminal can determine whether the received data request message is sent from an authorized user using user authentication information included in the received data request message.

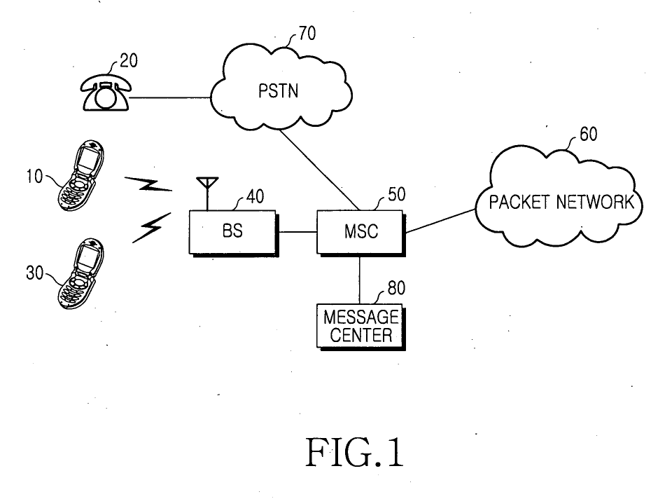

Hereinafter, an operation of a mobile communication terminal will be described with reference to FIG. 1, which shows a communication network including communication terminals according to the present invention.

Referring to FIG. 1, the communication system includes mobile terminals 10 and 30 and a wired terminal 20 as end terminals. The mobile terminals 10 and 30 are connected to a packet network 60 and a Public Switched Telephone Network (PSTN) 70 through a base station 40 and a Mobile Switching Center (MSC) 50. The packet network 60 is an IP network and provides an Internet service to the mobile terminals 10 and 30. The IP network includes all types of networks using Internet Protocol (IP) techniques as well as the Internet providing Internet applications such as e-mails or the World Wide Web (www).

A message center 80 is connected to the MSC 50 to manage a message received from the wired terminal 20 or a mobile communication terminal and transmit a message to a corresponding terminal. Although not shown in figures, the message center 80 may transmit a message received from a terminal connected to the packet network 60 to the end terminals 10, 20, and 30 may transmit the received message to another mobile communication terminal or wired terminal.

The end terminals 10, 20, and 30 according to the present invention may transmit a data request message in a conventional message type to other end terminals to request data stored in the other end terminals. The end terminals 10, 20, and 30 search for user desired information satisfying a search condition included in the received data request message and transmit the searched data to a destination included in the received data request message. At this time, the end terminals 10, 20, and 30 process the searched data into a message of a type suitable for the destination.

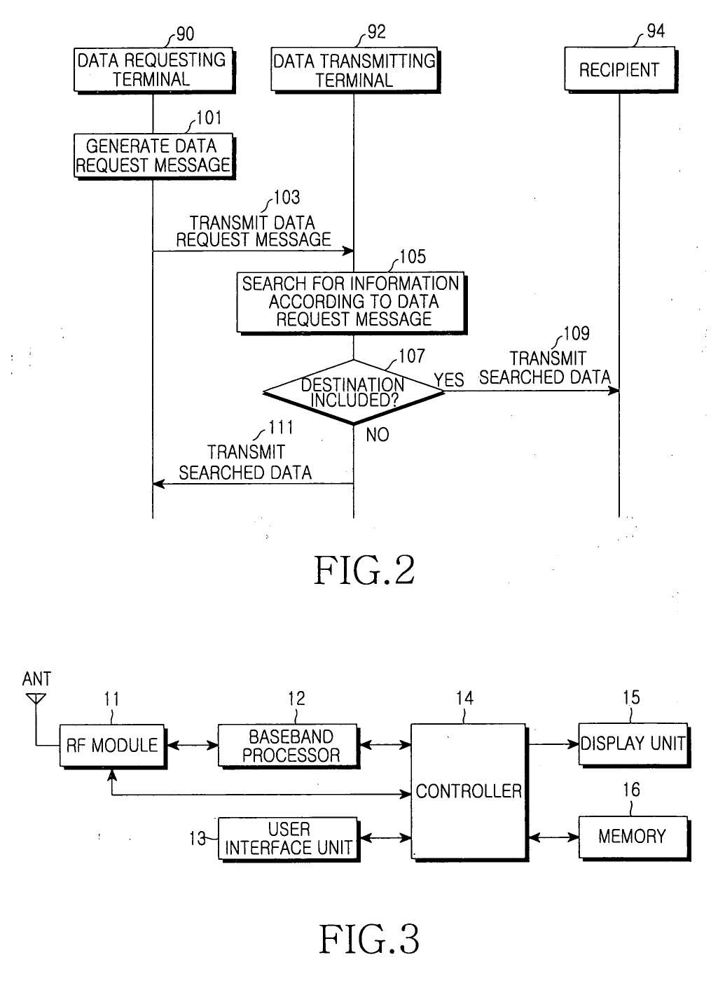

Hereinafter, a message flow diagram for providing data in the communication network according to the present invention will be described with reference to FIG. 2.

Referring to FIG. 2, a data requesting terminal 90 receives a search condition, security information, and a destination as inputs from a user and generates a data request message in step 101. The search condition is a condition used to search for user desired data. For example, the user may desire a telephone number, scheduling data, an SMS message, or a Multimedia Messaging Service (MMS) message stored in a data transmitting terminal 92. At this time, the search condition is used to acquire specific data desired by the user among such stored data. For example, if the search condition is one of names stored in a phone book, the data transmitting terminal 92 searches for a stored telephone number corresponding to the search condition, i.e., a name stored in the phone book. If the search condition is a date, the data transmitting terminal 92 searches for stored data corresponding to the date of a scheduler. If the search condition is a predetermined message, the data transmitting terminal 92 searches for data designated to be searched corresponding to the message. At this time, the predetermined message functions in a manner similar to a command.

The security information is used to determine whether the data request message is transmitted from an authorized user. In other words, the security information is used to determine whether the received data request message is an authorized data request message. Thus, the security information may be letters or numbers or a combination thereof set by a user or a password used by the data transmitting terminal 92 for other functions. The present invention is not limited to the above description and it is obvious that the security information can be modified by those skilled in the art. The destination is one to which the terminal transmitting terminal 92 is to transmit data searched according to the search condition. In other words, the destination is one by which data requested by the data requesting terminal 90 is to be received. The data requesting terminal 90 may not receive a destination as an input from a user. At this time, the destination may be a telephone number of a terminal transmitting the data request message. The data requesting terminal 90 may also automatically include a destination set to default in a data request message. At this time, all types of protocol that can be transmitted by the data transmitting terminal 92, such as a telephone number, a messenger ID, or an e-mail address, may be input as the destination.

Next, the data requesting terminal 90 transmits the generated data request message to the data transmitting terminal 92 in step 103.

Upon receipt of the data request message, the data transmitting terminal 92 checks if the received data request message is authorized using the security information included in the received data request message. The data transmitting terminal 92 searches in stored data for user desired information according to the data request message in step 105. The data transmitting terminal 92 determines whether destination information is included in the received data request message in step 107. As stated above, the data requesting terminal 90 may transmit a data request message having no destination address. If destination information is not included in the received data request message, the data transmitting terminal 92 may determine a telephone number of a terminal transmitting the data request message as a destination. If destination information is not included in the received data request message, the data transmitting terminal 92 goes to step 111 to transmit the searched data to the data requesting terminal 90. If destination information is included in the received data request message, the data transmitting terminal 92 transmits the searched data to a corresponding destination such as recipient terminal 94, in step 109. At this time, the data transmitting terminal 92 processes the searched data into a message of a type suitable for the destination. It is preferable that the searched data be transmitted in the form of an SMS message. However, if the destination is an e-mail address or a messenger ID, the searched data is processed suitable for the protocol.

In other words, the data transmitting terminal 92 transmits the searched data in the form of an SMS message, an MMS message, an e-mail message, or a messenger message according to a destination using Hyper Text Transfer Protocol (HTTP), Simple Mail Transfer Protocol (SMTP), Transmission Control Protocol/Internet Protocol (TCP/IP), or Real-time Transport Protocol (RTP). If transmission data is not completely transmitted through one-time transmission, the data transmitting terminal 92 continues transmission until the searched data is completely transmitted.

The data requesting terminal 90 may be any type of terminal capable of generating and transmitting a data request message according to the present invention. The data requesting terminal 90 may also be any type of terminal capable of receiving a data request message according to the present invention, searching for its stored data according to a search condition, and transmitting the searched data to a corresponding destination. In general, it is preferable that both a data request function and a data transmission function according to the present invention be implemented by a single terminal.

While a case where the present invention is applied to a mobile communication terminal will be described below, the present invention is not limited to the following description and those skilled in the art will understand that the present invention can also be applied to other types of terminals.

FIG. 3 is a block diagram of a mobile communication terminal according to the present invention. Referring to FIG. 3, the mobile communication terminal includes a Radio Frequency (RF) module 11, a baseband processor 12, a user interface unit 13, a controller 14, a display unit 15, and a memory 16. The controller 14 controls an overall operation of the mobile communication terminal and performs a data request function and a data transmission function according to the present invention.

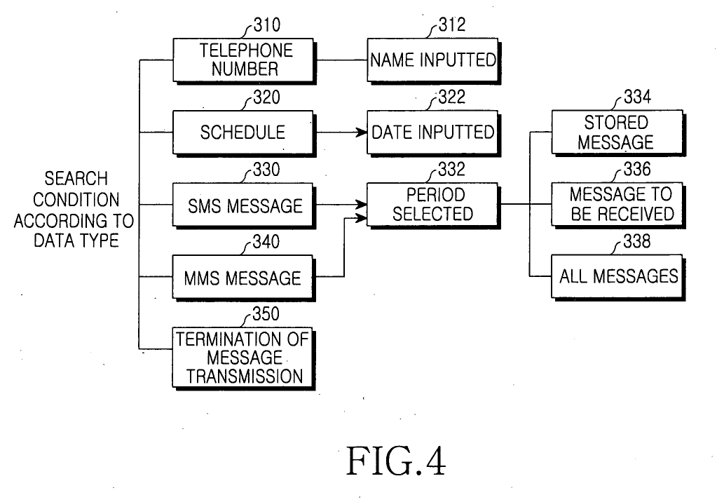

More specifically, to perform the data request function, the controller 14 receives security information, a search condition, and a destination as inputs from a user and generates and transmits a data request message. At this time, since the security information is used to determine whether a data request message is transmitted from an authorized user, it may be a password used by a data transmitting terminal for other functions. The search condition varies with the type of user desired information. FIG. 4 illustrates search conditions input according to types of data. Referring to FIG. 4, when the user desired information is a telephone number 310, the user inputs a stored name corresponding to the telephone number 310 as the search condition (312). When the user desired information is a schedule 320, the user inputs a date corresponding to a desired schedule as the search condition (322). When the user desired information is an SMS message 330 or an MMS message 340, the user selects a predetermined message identified by the received period of the message, i.e., selects a corresponding received period (322).

For example, if the user desires to re-transmit a received and then stored SMS message, the controller 140 inputs m1. If the user desires to re-transmit an SMS message to be received in real-time, the controller 140 inputs m2. If the user desires to re-transmit both received and then stored SMS messages and SMS messages to be received, the controller 140 inputs m3. The controller 140 inputs M1 if the user desires to re-transmit a received and then stored MMS message, inputs M2 if the user desires to re-transmit an MMS message to be received in real-time, and inputs M3 if the user desires to re-transmit both received and then stored MMS messages and MMS messages to be received. Thus, the user may select one of a stored message 334, a message to be received 336, and all messages 338.

The user may desire a data transmitting terminal not to transmit a message any more (350). At this time, the controller 14 uses a letter or a number corresponding to a control operation or a combination thereof as a search condition. For example, when the user desires termination of message transmission by the data transmitting terminal, the controller 14 inputs MO or mO regardless of whether a corresponding message is an SMS message or an MMS message. The present invention is not limited to the above description and it is obvious that the present invention can also be applied to a case where the user desires the data transmitting terminal to transmit another data. For example, a data requesting terminal requests transmission of a stored MP3 file from the data transmitting terminal.

A predetermined letter may be added to the search condition to indicate the search condition. At this time, the added letter may be positioned in front of or at the end of the search condition. For example, n is added to a name input to search for a telephone number and d is added to a date input to search for a schedule.

The controller 14 receives a destination as an input from the user, or the user may not input a destination. In this case, the controller 14 may select a destination set to default, e.g., its telephone number, or fill a destination field with 0.

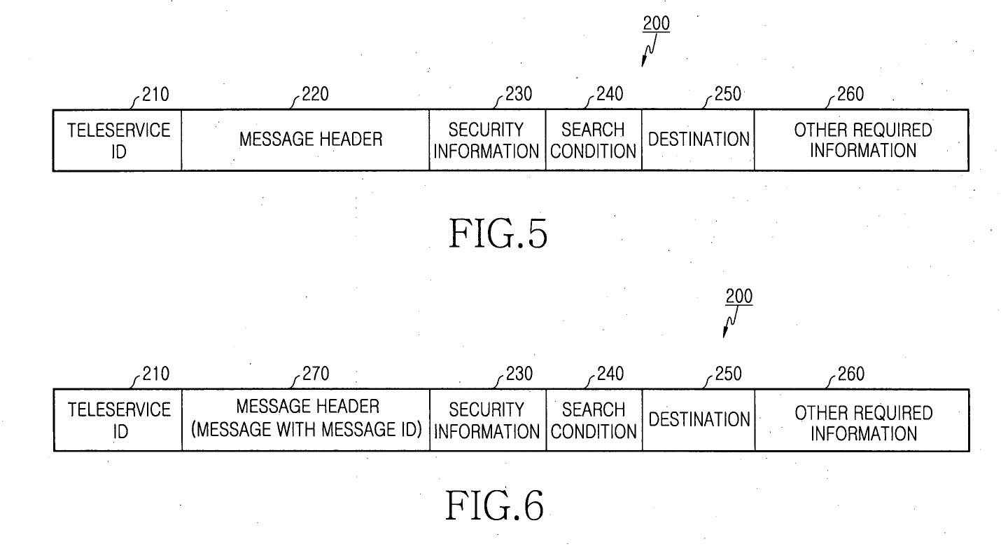

The data request message including the security information, the search condition, and the destination has a structure as shown in FIG. 5 according to an embodiment of the present invention. Referring to FIG. 5, a data request message 200 includes a teleservice ID field 210, a message header field 220, a security information field 230, a search condition field 240, a destination field 250, and other required information field 260. The teleservice ID field 210 is used to identify the service type of a message. The message header field 220 is a field for general header information. The security information, the search condition information, and the destination information are written to the security information field 230, the search condition field 240, and the destination field 250, respectively. The security information field 230, the search condition field 240, and the destination field 250 are loaded in a payload of a message.

FIG. 6 illustrates the structure of a data request message according to another embodiment of the present invention. The data request message shown in FIG. 6 is different from that shown in FIG. 5 only in terms of a message header and thus only a message header will be described. A message header field 270 of the data request message of FIG. 6 includes a message ID unlike the message header field 220 of FIG. 5. The message ID is used to indicate a data request message. Thus, a terminal receiving the data request message can recognize that the received message is a data request message by parsing the message header field 270.

The controller 14 divides the security information, the search condition, and the destination input by the user in the payload of a message using spaces. In other words, upon receipt of the security information, the search condition, and the destination from the user, the controller 14 loads the received information in the payload of the message according to a predetermined order and inserts a space between the successive information. The controller 14 transmits the generated data request message to a data transmitting terminal.

The user may also directly create a data request message. In this case, the controller 14 operates in the same manner as in general message writing. Thus, the terminal does not need to implement a data request function and the user can create a data request message using a general terminal.

Hereinafter, examples of combinations of a security information field, a search condition field, and a destination field will be described.
Security information n Tom: A telephone number stored in the name of Tom is transmitted to a data requesting terminal using an SMS.
Security information n Tom 0169999999: A telephone number stored in the name of Tom is transmitted to 016-999-9999 using an SMS.
Security information n Tom a@b.c: A telephone number stored in the name of Tom is transmitted to an e-mail address a@b.c.
Security information n Tom MSN a@b.c: A telephone number stored in the name of Tom is transmitted to an MSN ID a@b.c. _MSN is a name of messenger service. For example, when the current user is using the MSN messenger, it is possible to receive the telephone number stored in the name of Tom on the MSN messenger window of the user.
Security information d20041013: Schedule data corresponding to a date Oct. 13, 2004 is transmitted to a data requesting terminal using an SMS.
Security information d20041013 0169999999: Schedule data corresponding to a date Oct. 13, 2004 is transmitted to 016-999-9999 using an SMS.
Security information d20041013 a@b.c: Schedule data corresponding to a date Oct. 13, 2004 is transmitted to an e-mail address a@b.c.
Security information d20041013 MSN a@b.c: Schedule data corresponding to a date Oct. 13, 2004 is transmitted to an MSN ID a@b.c.
Security information m1: SMS messages that have been received are re-transmitted to a data requesting terminal using an SMS.
Security information m3 a@b.c: SMS messages that have been received are re-transmitted to a@b.c. using an SMS and SMS messages to be received are re-transmitted to a@b.c. using an SMS.
Security information m2 MSN a@b.c: SMS messages to be received are re-transmitted to an MSN ID a@b.c.
Security information M2: MMS messages to be received are re-transmitted to a data requesting terminal using an MMS.
Security information M2 0169999999: MMS messages to be received are re-transmitted to 016-999-9999 using an MMS.
Security information m0: An SMS message or an MMS message is not re-transmitted any more.

The combinations are only taken as examples and the present invention is not limited thereto.

Upon receipt of a data request message in implementing a data transmission function, the controller 14 checks if the received data request message is authorized using security information included in the received data request message. The controller 14 searches in stored data for user desired information according to a search condition of the received data request message and transmits the searched data to a destination of the received data request message. The controller 14 may transmit the searched data to a data requesting terminal if destination information is not included in the received data request message. The controller 14 may process the searched data into a message of a type suitable for a destination prior to transmission of the searched data. As mentioned above, the controller 14 transmits the searched data in the form of an SMS message, but it processes the searched data into a type suitable for corresponding protocol if the destination is an e-mail address or an MSN ID.

Referring back to FIG. 3, the display unit 15 receives and displays display data corresponding to key input data input from the user interface unit 13 under a control of the controller 14 or displays an operation state and plural information of a mobile communication terminal in the form of icons or letters. The user interface unit 13 includes a plurality of keys including number keys and provides the key input data input from the user to the controller 14. The memory 16 connected to the controller 14 includes a Read Only Memory (ROM) and a Random Access Memory (RAM) for storing a plurality of programs and data required for control of an operation of the mobile communication terminal, and a voice memory.

RF module 11 transmits an RF signal to and receives an RF signal from a base station through an antenna ANT. The RF module 11 converts the received RF signal into an Intermediate Frequency (IF) signal and outputs the IF signal to the baseband processor 12. The RF module 11 also converts an IF signal received from the baseband processor 12 into an RF signal and transmits the RF signal. Here, the baseband processor 12 is a baseband analog Application-Specific Integrated Circuit (ASIC) providing an interface between the controller 14 and the RF module 11. The baseband processor 12 converts a baseband digital signal applied from the controller 14 into an analog IF signal and applies the analog IF signal to the RF module 11 and converts an analog IF signal applied from the RF module 11 into a baseband digital signal and applies the baseband digital signal to the controller 14.

Hereinafter, control flowcharts when a terminal transmits a data request message and receives a data request message according to the present invention will be described.

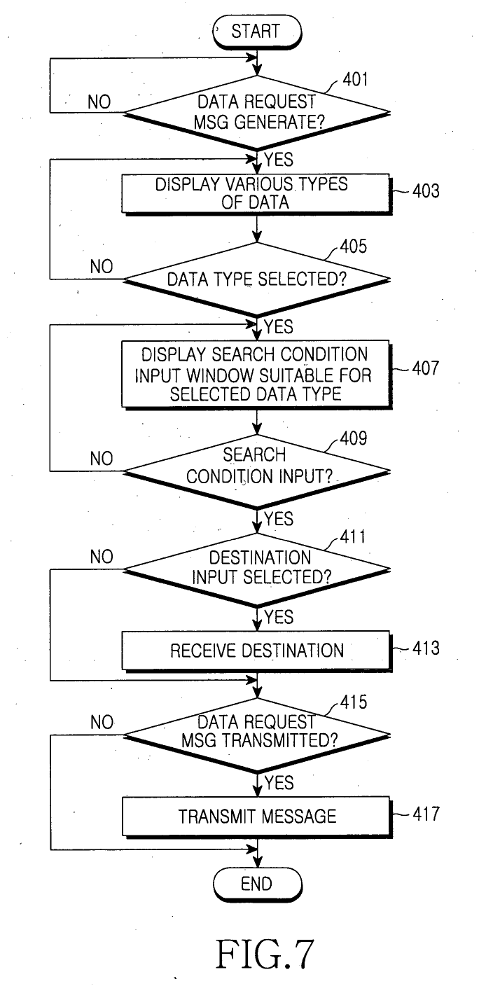

FIG. 7 is a control flowchart when a terminal transmits a data request message according to the present invention.

Referring to FIG. 7, the controller 14 determines whether a data request message creation menu is selected by a user in step 401. If the user desires to create a data request message, the controller 14 goes to step 403 to display user desired information types. The controller 14 goes to step 405 to determine whether the user selects a data type. If the user selects one of the displayed user desired information types, the controller 14 goes to step 407 to display a search condition input window suitable for the selected data type.

The controller 14 determines whether the user inputs a search condition in step 409. If the user inputs a search condition, the controller 14 goes to step 411 to determine whether the user selects a destination input menu. Since the user may not input a destination, the present invention may be configured to input a destination only when the destination input menu is selected. If the user selects the destination input menu, the controller 14 receives a destination as an input from the user in step 413. If not, the controller 14 proceeds to step 415. The controller 14 creates a data request message using user input information and determines whether the user requests transmission of the data request message in step 415. If the user selects transmission of the data request message, the controller 14 transmits the data request message in step 417. If not, the controller 14 ends the process.

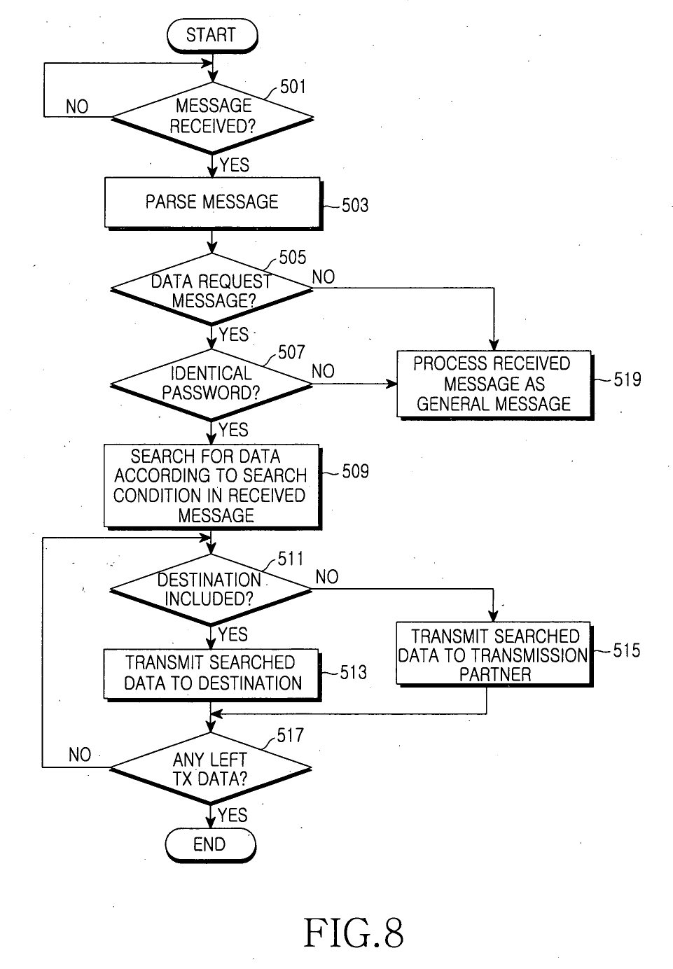

FIG. 8 is a control flowchart when the terminal receives the data request message according to the present invention.

The controller 14 determines whether a message is received in step 501. If the message is received, the controller 14 parses the received message in step 503. When a message shown in FIG. 5 is received, the controller 14 identifies the received message as a data request message based on a security field, a search condition field, and a destination field in the payload of the received message. When a message shown in FIG. 6 is received, the controller 14 identifies the received message as a data request message based on a message ID in a message header.

The controller 14 determines whether the received message is a data request message in step 505. If the received message is a data request message, the controller 14 goes to step 507 to determine whether security information of the data request message is authorized. In other words, the controller 14 determines whether the data request message is an authorized message. Although the security information is a password and the controller 14 determines whether the received password is identical to its stored password, the present invention is not limited thereto. If the received message is not a data request message or security information is not authorized, the controller 14 goes to step 519 and processes the received message as a general message.

If the received password is identical to a password stored in the controller 14, the controller 14 goes to step 509 to search for its stored data according to a search condition of the received message. The controller 14 goes to step 511 to determine whether destination information is included in the data request message. If the data request message does not include the destination information, the controller 14 goes to step 515 to transmit the searched data to a partner that transmits the data request message. If the data request message includes the destination information, the controller 14 goes to step 513 to transmit the searched data to a corresponding destination. The controller 14 determines whether there remains transmission data in step 517. There is a possibility that the controller 14 cannot completely transmit the searched data through one-time transmission. In this case, the controller 14 performs several transmissions until the entire searched data is completely transmitted.

According to the present invention, users can acquire data stored in a mobile communication terminal even when they do not carry the mobile communication terminal with them.

While the present invention has been shown and described with reference to preferred embodiments thereof, it will be understood by those skilled in the art that various changes in form and details may be made therein without departing from the spirit and scope of the invention. For example, although a mobile communication terminal is taken as an example in an embodiment of the present invention, the present invention can also be applied to most terminals transmitting and receiving a data request message according to the present invention. In addition, security information, a search condition, and a destination are only taken as examples and can be modified variously by those skilled in the art.

What is claimed is:

1. A method for providing stored data, comprising the steps of:
determining whether a data request message is received;
searching in stored data for user desired information according to a search condition included in the data request message upon receipt of the data request message; and
transmitting the user desired information satisfying the search condition according to a destination included in the data request message.

2. The method of claim 1, further comprising determining whether the data request message is an authorized message by referring to security information included in the data request message and searching for the user desired information if the data request message is an authorized message.

3. The method of claim 2, wherein the security information is a stored password.

4. The method of claim 1, wherein the user desired information is one of all types of data that can be provided by a terminal, such as a telephone number, scheduling data, an SMS message, and an MMS message.

5. The method of claim 1, wherein the destination is one of all ways through which data can be received, such as a telephone number, an e-mail address, a messenger ID, and a transmission side transmitting the data request message.

6. The method of claim 1, further comprising continuing data transmission until the searched data is completely transmitted if a portion of the searched data remains after the transmission.

7. An apparatus for providing stored data, comprising:
a receiver for receiving a message; and
a controller for searching in its stored data for user desired information according to a search condition included in a data request message upon receipt of the data request message and transmitting the user desired information satisfying the search condition to a destination included in the data request message.

8. The apparatus of claim 7, wherein the controller determines whether the data request message is an authorized message by referring to security information included in the data request message, and searches for the data if the data request message is an authorized message.

9. The apparatus of claim 8, wherein the security information is a stored password.

10. The apparatus of claim 7, wherein the user desired information is one of all types of data that can be provided by a terminal, such as a telephone number, scheduling data, an SMS message, and an MMS message.

11. The apparatus of claim 7, wherein the destination is one of all ways through which data can be received, such as a telephone number, an e-mail address, a messenger ID, and a transmission side transmitting the data request message.

12. The apparatus of claim 7, wherein the controller continues data transmission until the searched data is completely transmitted if a portion of the searched data remains after the transmission.

13. A method for requesting stored data in a communication system, in which a first communication device requests data stored in a second communication device, the method comprising the steps of:
receiving, as an input from a user, a search condition for searching in the stored data of the second communication device for user desired information if the user selects a data request function;
receiving, as an input from the user, a destination to which the user desired information is to be transmitted; and
generating a data request message using the input search condition and destination.

14. The method of claim 13, further comprising:
receiving, as an input from the user, security information indicating that the data request message is generated by an authorized user; and
inserting the input security information in the data request message.

15. The method of claim 13, wherein the security information is a password of the second communication device.

16. The method of claim 13, wherein the destination is one of all ways through which data can be received, such as a telephone number, an e-mail address, a messenger ID, and a transmission side transmitting the data request message.

17. The method of claim 13, wherein if the user desired information is a telephone number, the search condition is a name stored in a phone book of the second communication device.

18. The method of claim 13, wherein if the user desired information is schedule data, the search condition is a date.

19. The method of claim 13, wherein the step of generating the data request message comprises determining each field value of the data request message according to information input by the user.

20. A communication device requesting data stored in another communication device in a communication system, the communication device comprising:
a controller for generating a data request message using a search condition and a destination input from a user if the user selects a data request function, the search condition being used to search for user desired information in the data stored in the another communication device and the destination to which the user desired information is to be transmitted; and
a transmitter for transmitting the generated data request message to the another communication device.

21. The communication device of claim 20, wherein the controller determines each field value of the data request message according to information input by the user.

22. The communication device of claim 20, wherein the controller receives, as an input from the user, security information indicating that the data request message is generated by an authorized user and inserts the security information in the data request message.
